(19) United States
(12) Patent Application Publication
(10) Pub. No.: US 2007/0120929 A1
(43) Pub. Date: May 31, 2007

(54) Ink Jet Process

(76) Inventors: Chuan-Yi Wu, Taipei City (TW); Yi-Pen Lin, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,539

(22) Filed: Nov. 29, 2005

(51) Int. Cl. B41J 2/01

(52) U.S. Cl. 347/102

(57) ABSTRACT

An ink jet process includes: providing a substrate; performing a ink jet step for spraying a paste on the surface of the substrate; and performing an in-situ and partial heating process to directly heat the paste sprayed on the surface of the substrate and control the shape and location of the paste.

### BACKGROUND OF THE INVENTION

1. Field of the Invention

The invention relates to an ink jet process, and more particularly, to an ink jet process utilizing a heating light source.

2. Description of the Prior Art

The advantages of the liquid crystal displays (LCDs) include lighter weight, less electrical consumption, and less radiation contamination than their CRT counterparts. Thus, the LCDs have been widely applied to several portable information products, such as: notebook computers, PDAs, etc. Additionally, the LCDs are gradually replacing the CRT monitors of the conventional desktop computers. The incident light will produce different polarization or refraction when the alignments of these liquid crystal molecules are different. The LCDs utilize the characteristics of the liquid crystal molecules to control the light transmittance and produce gorgeous images.

In general, liquid crystal displays include a thin film transistor (TFT) array substrate, a color filter (CF) substrate, and liquid crystal filled between the TFT array substrate and the color filter substrate. The TFT array substrate further includes a transparent substrate, such as a glass substrate, in which the surface of the substrate includes a plurality of thin film transistors aligned in arrays, pixel electrodes, scan lines and data lines, and electronic devices such as capacitors and connecting pads for driving liquid crystal pixels and producing colorful images. The color filter substrate on the other hand, includes a transparent substrate, in which the surface of the transparent substrate further includes a common electrode and a plurality of color filters aligned in arrays.

According to the conventional method of fabricating liquid crystal displays, a plurality of photo-etching processes (PEP) are commonly utilized to form the pixel electrodes, scan lines, and data lines on the TFT array substrate. The fabrication of the color filter substrate on the other hand, primarily includes the coating of red, green, and blue color photoresist, cell gap alignment and exposure, and a development process. However, in addition to performing numerous photolithography and cleaning processes, the total material usage of the conventional coating of the red, green, and blue color photoresist is only 1-2%. Additionally, numerous depositions, photolithography, etching, and cleaning processes must be performed on the TFT array substrate for fabricating pixel electrodes, scan lines, and data lines, thereby increasing the chance of damaging the transparent substrate and the fabricated patterns should the substrate and patterns come in contact with any of the numerous chemical agents utilized. Ink jet processes have been widely utilized to improve this process and reduce the various disadvantages that are inherent in the conventional multi-step processes for fabricating liquid crystal displays.

Please refer to FIG. 1. FIG. 1 is a perspective diagram of a conventional ink jet process. As shown in FIG. 1, a glass substrate 26, such as a color filter substrate, is provided, and an ink jet equipment 20 is utilized to fabricate a color filter pattern on the glass substrate 26. Preferably, the ink jet equipment 20 includes at least a print head 22 and a controller (not shown), and the surface of the glass substrate 26 includes a black matrix 28 for increasing the contrast of the liquid crystal display and shielding the non-transparent portion of the thin film transistors on the TFT array substrate, scan lines, and data lines. Subsequently, a color photoresist paste 24 is sprayed in the gaps of the black matrix 28 and on the exposed surface of the glass substrate 26. Next, a curing process is performed by moving the glass substrate 26 to a high temperature oven to harden the paste coated over the surface of the glass substrate 26.

The conventional ink jet process primarily includes two steps. In the first step, the print head 22 is utilized to spray a paste over the surface of the glass substrate 26. The second step happens after the entire glass substrate 26 is coated with the paste. In the second step, the glass substrate 26 is moved to a high temperature oven for a curing process. If a large area device, such as a hot plate were utilized to directly bake the glass substrate 26, the high temperature produced by the hot plate would cause two unwanted results. First, the hot plate will plug the print head 22. Second, this method will cause uneven baking time for each pattern formed on the glass substrate 26. Furthermore, the two step approach of the conventional inkjet process increases the total time required by the fabrication process.

Because the two step approach of the conventional ink jet process often cannot control the size of the paste sprayed over the surface of the glass substrate, Japanese Patent No. JP08-29776 has disclosed a method of applying silica to increase the surface tension between the colored photoresist paste and the glass substrate. Nevertheless, this method will not only increase the number of fabrication steps and the overall cost of manufacturing, but also reduce the light penetration of the liquid crystal display. Moreover, the proposed method is unable to be applied to other materials that can be sprayed via the ink jet process, including polyimide, silver paste, and liquid crystals.

### SUMMARY OF THE INVENTION

It is therefore an objective of the claimed invention to provide an ink jet process to improve the conventional ink jet process of utilizing a two step approach which results in problems such as paste overflow and uneven size and shape of the paste.

According to the claimed invention, an ink jet process is disclosed, comprising: providing a substrate; performing a ink jet step for spraying a paste on the surface of the substrate; and performing an in-situ and partial heating process to directly heat the paste sprayed on the surface of the substrate and control the shape and location of the paste.

In contrast to the conventional ink jet process, the claimed invention utilizes the combination of a heating light source and an optical system to partially heat the paste just sprayed on a glass substrate thereby controlling the heating area and heating time of the paste. Additionally, the heating light source of the claimed invention is able to move in synchrony with the print head, thereby maintaining the shape and size of the paste and reducing problems such as plugged print heads, overflow of the paste, and uneven paste size and shape as caused by the conventional ink jet process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram of a conventional ink jet process.

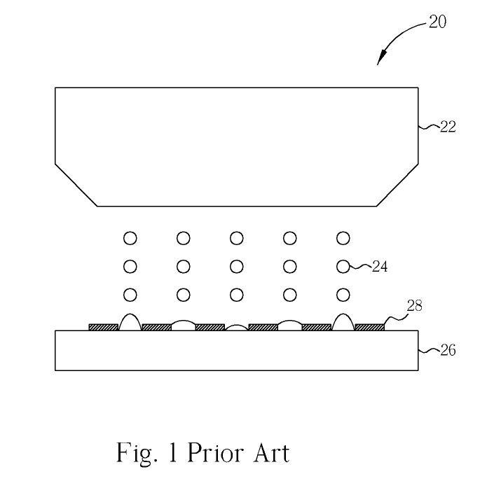

FIG. 2 is a perspective diagram showing the ink jet process according to the present invention.

FIG. 3 is a block diagram showing the ink jet equipment according to the present invention.

### DETAILED DESCRIPTION

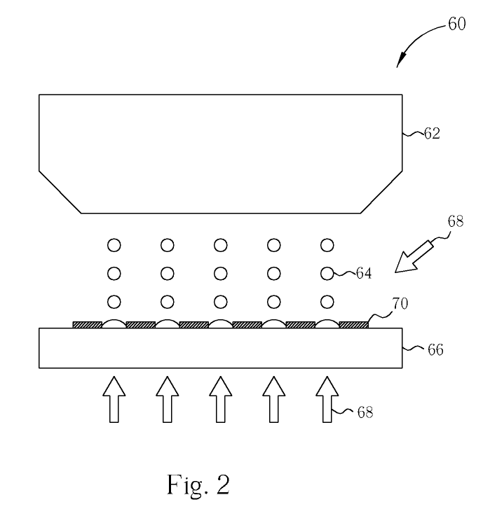

Please refer to FIG. 2. FIG. 2 is a perspective diagram showing the ink jet process according to the present invention. As shown in FIG. 2, a glass substrate 66, such as a color filter substrate, is provided, and an ink jet equipment 60 is utilized to fabricate the required color filter pattern on the glass substrate 66. Preferably, the ink jet equipment 60 includes at least a print head 62 and a controller (not shown) that functions to provide paste to the print head 62 and also to control the movement of the print head 62. Additionally, the surface of the glass substrate 66 includes a black matrix 70 for increasing the contrast of the liquid crystal display and shielding the non-transparent portion of the thin film transistors on the TFT array substrate, scan lines, and data lines. Subsequently, a colored photoresist paste 64 is sprayed onto the surface of the glass substrate 66 by utilizing the print head 62 according to various fabrication processes and product requirements.

As shown in FIG. 2, when the paste 64 is sprayed over the surface of the glass substrate 66, an in-situ ink jet step is performed by utilizing an optical system (not shown) to focus a heating light source 68 composed of infrared light, ultraviolet light, or laser and partially heat the paste 64 just sprayed on the surface of the glass substrate 66. In other words, since the heating area of the heating light source 68 can be controlled by the optical system, the present invention is able to provide a partial heat treatment to the paste 64 and at the same time effectively control the heating time of every heating area. Moreover, when the glass substrate 66 is moved to the next region for further ink jet process, the heating light source 64 and the print head 62 will move in synchrony and corresponding to the glass substrate 66 to ensure every area of the paste 64 is heated under an equal amount of time.

The ink jet process of the present invention can not only be applied to the color filter substrate fabrication for producing patterns for color filters, but also can be applied to other fabrication processes regarding the fabrication of color filter substrate or TFT array substrate, in which the paste sprayed over the surface of the glass substrate may include any material that can be sprayed via the ink jet process including colored photoresist, black matrix, polyimide, silver paste, palladium oxide (PdO), and liquid crystal.

Since various pastes 64 can be utilized according to different product requirements and fabrication designs, the present invention is capable of utilizing many different heating light sources 68 to heat the various different pastes 64. For instance, the present invention is able to utilize ultraviolet light to heat colored photoresist, polyimide, and liquid crystal, utilize infrared light to heat liquid metals, polyimide, and silver paste, and utilize laser to heat silver paste. Preferably, the polyimide commonly utilized for fabricating alignment film can be heated by both infrared light and ultraviolet light, and silver paste and PdO can also be heated by utilizing both infrared light and laser.

In general, the surface of the glass substrate 66 includes weaker tension and adhesion ability, hence when the paste 64 is sprayed in the gaps of the black matrix 70 and on the exposed surface of the glass substrate 66, the shape of the paste 64 will be difficult to control. By utilizing the heating light source 68 to perform a rapid heating process to the paste 64 sprayed on the glass substrate 66, the present invention is able to effectively control the shape and location of the paste 64. Additionally, the partial heating process of the present invention can be applied to fabrication processes involving different pastes, such as preventing colored photoresist from overflow, controlling the size and shape of the silver metal while spraying the silver paste, and solidifying each cell gap while spraying the liquid crystal.

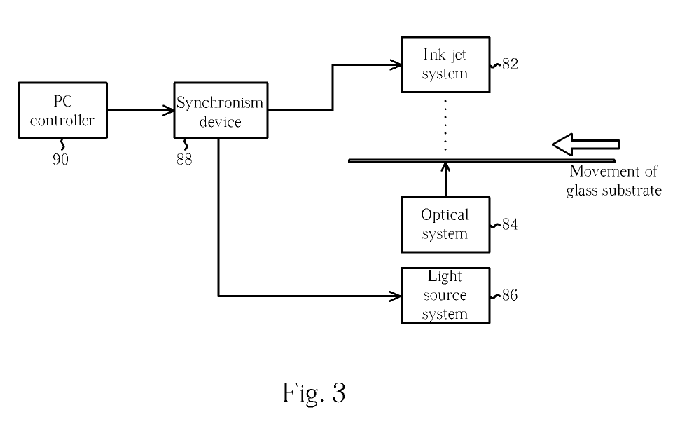

Please refer to FIG. 3. FIG. 3 is a block diagram showing the ink jet equipment according to the present invention. As shown in FIG. 3, the ink jet equipment includes an ink jet system 82, an optical system 84 for focusing the heating light source, a light source system 86 for providing various kinds of heating light sources, a synchronism device 88, and a PC controller 90. Preferably, the ink jet system 82 includes at least a print head and a controller for providing paste to the print head. Ideally, when the ink jet system 82 sprays a paste on a glass substrate, the optical system 86 will provide a heating light source composed of infrared light, ultraviolet light, or laser and the heating light source is then focused via the optical system 84. Subsequently, the focused heating light source is utilized to partially heat the paste sprayed on the glass substrate for controlling the shape and location of the paste. Additionally, when the heating light source is utilized to heat the paste, users can manipulate the synchronism device 88 and the PC controller 90 simultaneously to allow the print head of the ink jet system 82 to move in synchrony with the heating light source, such that the heating light source will be able to heat the paste at the same time when the glass substrate is moving, thereby effectively controlling the shape and location of the paste.

In contrast to the conventional ink jet process, the present invention utilizes the combination of a heating light source and an optical system to partially heat the paste just sprayed on a glass substrate thereby controlling the heating area and heating time of the paste. Additionally, the heating light source of the present invention is able to move in synchrony with the print head, thereby maintaining the shape and size of the paste and reducing problems such as plugged print heads, overflow of the paste, and uneven paste size and shape as caused by the conventional ink jet process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ink jet process comprising:
providing a substrate;
performing an inkjet step for spraying a paste on the surface of the substrate; and
performing an in-situ and partial heating process to directly heat the paste sprayed on the surface of the substrate and control the shape and location of the paste.

2. The ink jet process of claim 1, wherein the substrate comprises a thin film transistor (TFT) array substrate or a color filter (CF) substrate.

3. The inkjet process of claim 2, wherein the surface of the color filter substrate further comprises a black matrix.

4. The inkjet process of claim 3, wherein the paste is sprayed in the gaps of the black matrix.

5. The ink jet process of claim 1, wherein the paste comprises photoresist, polyimide, silver paste, palladium oxide (PdO), or liquid crystal.

6. The ink jet process of claim 1, wherein the partial heating process is performed by utilizing a heating light source.

7. The ink jet process of claim 6, wherein the heating light source comprises infrared light, ultraviolet light, and laser.

8. The ink jet process of claim 7, wherein the heating light source is focused by an optical system for heating the paste sprayed over the surface of the substrate.

9. The ink jet process of claim 6, wherein the ink jet process is performed by utilizing an ink jet equipment.

10. The ink jet process of claim 9, wherein the ink jet equipment comprises at least a print head and a controller for spraying the paste and controlling the direction of the print head.

11. The ink jet process of claim 10, wherein the heating light source and the print head are moving in synchrony and corresponding to the substrate.
